(19) United States
(12) Patent Application Publication
(10) Pub. No.: US 2026/0326605 A1
(43) Pub. Date: Oct. 22, 2026

(54) TRAVELING VEHICLE SYSTEM

(71) Applicant: Murata Machinery, Ltd., Kyoto-shi, Kyoto (JP)

(72) Inventors: Wataru KITAMURA, Inuyama-shi (JP); Shota MIZUTA, Inuyama-shi (JP)

(21) Appl. No.: 19/114,006

(22) PCT Filed: Sep. 11, 2023
(86) PCT No.: PCT/JP2023/032997

§ 371 Date: Mar. 21, 2025

(30) Foreign Application Priority Data
Sep. 26, 2022 (JP) 2022-152633

(51) Int. Cl. B60L 53/66; B60L 53/67

(52) U.S. Cl. CPC B60L 53/66; B60L 53/67; B60L 2240/72

(57) ABSTRACT

A traveling vehicle system includes traveling vehicles, chargers capable of charging the traveling vehicles, and a controller configured or programmed to control traveling of the traveling vehicles and charging of the traveling vehicles. The controller includes a processor configured or programmed to select one of the chargers to charge the traveling vehicle to be charged based on location information of the traveling vehicle to be charged, location information of the charger, and charging wait information about a charging wait status of the traveling vehicle at the charger, if the traveling vehicle requiring charging is present; a traveling controller configured or programmed to cause the traveling vehicle to be charged to travel to a charging location where the traveling vehicle can be charged by the charger selected by the processor; and a charging controller configured or programmed to cause the charger to charge the traveling vehicle at the charging location.

### BACKGROUND OF THE INVENTION

### 1. Field of the Invention

The present invention relates to traveling vehicle systems.

### 2. Description of the Related Art

International Publication No. 2012/147125 discloses a navigation device that searches for charging facilities for electric vehicles. This navigation device is mounted on an electric vehicle, searches for charging facilities that are located within a predetermined distance range from the vehicle's own location, and presents the search results to the user in the electric vehicle.

### SUMMARY OF THE INVENTION

In the technique mentioned above, the user typically selects the charging facility closest to the location of their own vehicle from among the presented charging facilities. However, a shorter distance does not always guarantee that charging can start earlier. Such a problem is not limited to electric vehicles but is common to traveling vehicles that travel on electricity as a drive source.

Example embodiments of the present invention provide traveling vehicle systems each enabling early charging of a traveling vehicle.

A traveling vehicle system according to an example embodiment of the present invention includes a plurality of traveling vehicles, a plurality of chargers capable of charging the traveling vehicles, and a controller configured or programmed to control traveling of the traveling vehicles and charging of the traveling vehicles by the charger, wherein the controller is configured or programmed to include a processor configured or programmed to select the charger to charge one of the plurality of traveling vehicles to be charged based on location information of the traveling vehicle to be charged, location information of the charger, and charging wait information that indicates a charging wait status of the traveling vehicle at the charger, if the traveling vehicle requiring charging is present, a traveling controller configured or programmed to cause the traveling vehicle to be charged to travel to a charging location where the traveling vehicle can be charged by the charger selected by the processor; and a charging controller configured or programmed to cause the charger to charge the traveling vehicle at the charging location.

According to the traveling vehicle system of the above example embodiment, a processor is configured or programmed to select the charger to charge the traveling vehicle to be charged from the plurality of chargers, taking into account both location information of the charger and charging wait information indicating a charging wait status, and it is thus possible to perform early charging.

The controller may be configured or programmed to include a plurality of communicators to communicate with the traveling vehicles located within different managed ranges in a travel range of the traveling vehicles, and the processor may be configured or programmed to receive information on the traveling vehicle located within each of the managed ranges from the plurality of communicators, and select the charger within the managed range to which a current location of the traveling vehicle to be charged belongs. According to such a configuration, a charger at a location relatively close to the traveling vehicle to be charged can be selected, enabling charging to be performed on the traveling vehicle earlier. Furthermore, the communicator communicating with the traveling vehicle does not need to be switched to another communicator until the traveling vehicle reaches the charger.

The processor may be configured or programmed to select the charger within the managed range to which the current location of the traveling vehicle to be charged belongs, even if all the chargers in the managed range are in use and the charger in another managed range is available. This configuration reduces or prevents the selection of a charger located far from the current location of the traveling vehicle to be charged, enabling earlier charging for the traveling vehicle.

The processor may be configured or programmed to treat as a selection target the charger for which a route length from the traveling vehicle to be charged to the charging location is equal to or less than a predetermined distance, or for which a route cost from a current location of the traveling vehicle to be charged to the charging location is equal to or less than a predetermined value. This configuration reduces or prevents the selection a charger located far from the current location of the traveling vehicle to be charged, enabling earlier charging for the traveling vehicle.

The charging wait status may be a number of the traveling vehicles waiting to be charged at the charger. The processor may be configured or programmed to select the charger that charges the traveling vehicle to be charged, based on a first parameter calculated by substituting a route cost from a current location of the traveling vehicle to be charged to the charging location and a value indicating the charging wait status of the charger into a first predetermined function. This configuration reduces the imbalance in the charging-waiting-vehicle count at each charger. As a result, the charging target can be charged early.

The processor may be configured or programmed to select the charger for which a value obtained by dividing a route length from a current location of the traveling vehicle to be charged to the charging location by a route cost for the route length is equal to or less than a threshold value. There may be included a power supplier connected to the plurality of chargers and supplying electric power to the chargers, the power supplier may be capable of supplying electric power to only one of the plurality of chargers, rather than simultaneously supplying electric power to the plurality of chargers, and the processor may be configured or programmed to select the charger that charges the traveling vehicle to be charged, based on a second parameter calculated by substituting the route cost, a first charge-waiting-vehicle count, and a second charging-waiting-vehicle count into a second predetermined function, where the first charge-waiting-vehicle count is a number of the traveling vehicles waiting to be charged at the charger, and the second charging-waiting-vehicle count is a number of the traveling vehicles waiting to be charged by the power supplier. According to such a configuration, the imbalance in the charging-waiting-vehicle count at each power supplier and the imbalance in the charging-waiting-vehicle count at each charger are reduced. As a result, the charging target can be charged earlier.

There may be included tracks in a grid pattern on which the traveling vehicle travels, and the charging location may be set within a first grid cell among a plurality of grid cells defined by the tracks, in which the charger can charge the traveling vehicle to be charged. If another of the traveling vehicles is present in the first grid cell, the traveling controller may be configured or programmed to cause the traveling vehicle to be charged to travel to a second grid cell, which is different from the first grid cell, as a waiting location, and the second grid cell may be set at a grid cell that is within a predetermined range from the first grid cell and through which the traveling vehicle passes least frequently. According to such a configuration, it is possible to prevent traveling vehicles waiting to be charged from obstructing the traveling of traveling vehicle in the transport process.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic configuration diagram of a traveling vehicle system according to an example embodiment of the present invention.

FIG. 2 is a diagram showing an example of tracks according to an example embodiment of the present invention.

FIG. 3 is a perspective view showing an example of a traveling vehicle according to an example embodiment of the present invention.

FIG. 4 is a diagram for describing a method for setting selection targets according to an example embodiment of the present invention.

FIG. 5 is a diagram for describing an example of a method for selecting a charging operation target according to an example embodiment of the present invention.

FIG. 6 is a flowchart of a first example of a method for selecting a charging operation target according to an example embodiment of the present invention.

FIG. 7 is a flowchart of a second example of a method for selecting a charging operation target according to an example embodiment of the present invention.

FIG. 8 is a flowchart of a third example of a method for selecting a charging operation target according to an example embodiment of the present invention.

FIG. 9 is a flowchart of a fourth example of a method for selecting a charging operation target according to an example embodiment of the present invention.

### DETAILED DESCRIPTION OF THE EXAMPLE EMBODIMENTS

Hereinafter, example embodiments of the present invention will be described. However, the present invention defined in the claims is not limited to the following example embodiments and modifications or combinations thereof, and not all combinations of features described in the example embodiments are essential to the present invention. In the drawings, the same or similar members are denoted by the same reference signs, and redundant descriptions may be omitted. The shape and size of the elements in the drawings may be exaggerated for the purpose of clearer description.

An XYZ Cartesian coordinate system may be used to describe directions in each drawing. In the XYZ coordinate system, a plane that is parallel to a horizontal plane is defined as an XY plane. A direction perpendicular to the XY plane is denoted as Z direction. For each of the X direction, the Y direction, and the Z direction, description is made with a definition in which a direction indicated by an arrow is the positive (+) direction and a direction opposite to the direction indicated by the arrow is the negative (−) direction.

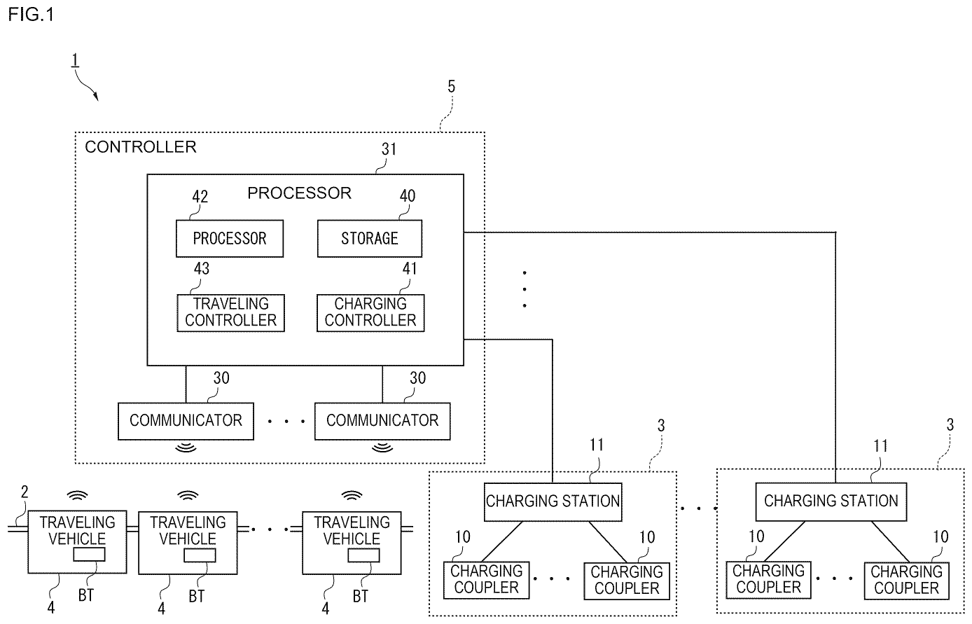

FIG. 1 is a schematic configuration diagram of a traveling vehicle system 1 according to the present example embodiment. As shown in FIG. 1, the traveling vehicle system 1 includes tracks 2, a plurality of charging facilities 3, a plurality of traveling vehicles 4, and a controller 5.

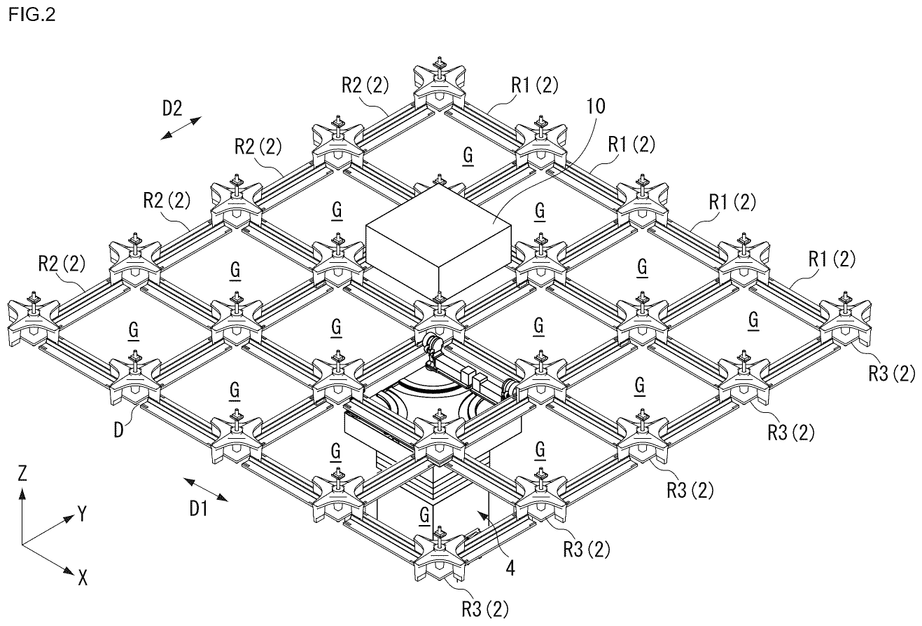

The tracks 2 are routes along which the traveling vehicle 4 can travel. FIG. 2 is a diagram showing an example of the tracks 2 according to the present example embodiment. For example, the tracks 2 are grid-patterned tracks. In other words, the tracks 2 are grid-patterned tracks that are arranged to define a grid pattern in a plan view. The grid-patterned tracks are an example of the tracks 2. The tracks 2 are installed, for example, on or in the vicinity of the ceiling of a building such as a clean room.

The tracks 2 include first tracks R1, second tracks R2, and partial tracks R3. The first tracks R1 are provided along the X direction (first direction). The second tracks R2 are provided along the Y direction (second direction). In the present example embodiment, a plurality of the first tracks R1 and a plurality of the second tracks R2 are provided along directions orthogonal to each other but not intersecting directly with each other. The partial track R3 is arranged at each intersecting portion where the first track R1 and the second track R2 intersect with each other.

The tracks 2 are provided along directions in which the first track R1 and the second track R2 are orthogonal to each other. The tracks 2 are configured with grid-patterned cells (“grid cells”) G, arranged adjacent to one another in a plan view. The traveling vehicle 4 preferably has a size that fits in a single grid cell G as seen in a plan view. This configuration enables the traveling vehicles 4 on adjacent tracks 2 to pass one another, and when multiple traveling vehicles 4 are arranged on the tracks 2, it increases the range in which each traveling vehicle 4 can travel without interfering with other traveling vehicles 4.

The first tracks R1, the second tracks R2, and the partial tracks R3 are suspended from the ceiling by suspenders (not shown in the drawings). The first tracks R1, the second tracks R2, and the partial tracks R3 are provided along the same or substantially the same horizontal plane (XY plane).

Each charging facility 3 is connected to the controller 5 either through a wired connection or wirelessly. The charging facility 3 charges a battery BT mounted on the traveling vehicle 4. The charging facility 3 includes a plurality of charging couplers 10 and a charging station 11. The charging coupler 10 is an example of the “charger”. The charging station 11 is an example of the “charger”. In other words, the “charger” may be the charging coupler 10 or the charging station 11.

Each charging coupler 10 is connected to a charging station 11. Each charging coupler 10 is installed, for example, in correspondence with a single cell of the grid-patterned tracks 2. The charging coupler 10 is, for example, a charging coupler. The charging coupler 10 is electrically connected to the traveling vehicle 4, whereby electric power from the charging station 11 is supplied to the traveling vehicle 4 via the charging coupler 10. Here, each charging coupler 10 is fixed at a predetermined location above the patterned tracks 2. Therefore, in order for the traveling vehicle 4 to charge its battery BT, it is necessary to travel to the charging location of one of the charging couplers 10 on the tracks 2.

The charging station 11 is connected to each of the multiple charging couplers 10. The charging station 11 charges the battery BT mounted on the traveling vehicle 4 by supplying electric power to the charging coupler 10 connected to the traveling vehicle. For example, the charging station 11 supplies electric power to the charging coupler 10 to which the traveling vehicle 4 is connected, based on a charging instruction from the controller 5. For example, when the charging coupler 10 is connected to the traveling vehicle 4, communication with the traveling vehicle 4 is established. As a result, the charging station 11 can determine which of the multiple charging couplers 10 is connected to the traveling vehicle 4. However, the present invention is not limited to this example, and the charging station 11 may use a commonly known technique to identify the connection between the charging coupler 10 and the traveling vehicle 4. Information about which charging coupler 10 is connected to the traveling vehicle 4 is transmitted to the controller 5.

Here, when each of the multiple charging couplers 10 is connected to a traveling vehicle 4, the charging station 11 supplies electric power to only one charging coupler 10, rather than supplying electric power to the multiple charging couplers 10 simultaneously. That is to say, the charging station 11 does not supply electric power to multiple traveling vehicles 4 at the same time, but supplies electric power to one traveling vehicle 4 at a time. In other words, the charging station 11 can supply electric power to only one charging coupler 10 at a time.

The number of charging couplers 10 connected to a single charging station 110 may differ depending on the charging facility 3. That is to say, the number of charging couplers 10 connected to a single charging station 11 may differ across all charging facilities 3. In other words, the number of charging couplers 10 connected to the charging station 11 of a first charging facility 3 among the multiple charging facilities 3 may differ from the number of charging couplers 10 connected to the charging station 11 of a second charging facility 3.

Each traveling vehicle 4 preferably includes a battery BT and travels along the tracks 2 using the electric power stored in the battery BT as its driving source. For example, the traveling vehicle 4 is a transport vehicle that transports articles W. As an example, the traveling vehicle 4 transports articles W, such as semiconductor wafers, in the clean room of a semiconductor manufacturing factory, for example. The article W is, for example, a Front-Opening Unified Pod (FOUP) or a reticle pod that accommodates reticles. The traveling vehicle system 1 is also applicable to facilities in fields other than semiconductor device manufacturing.

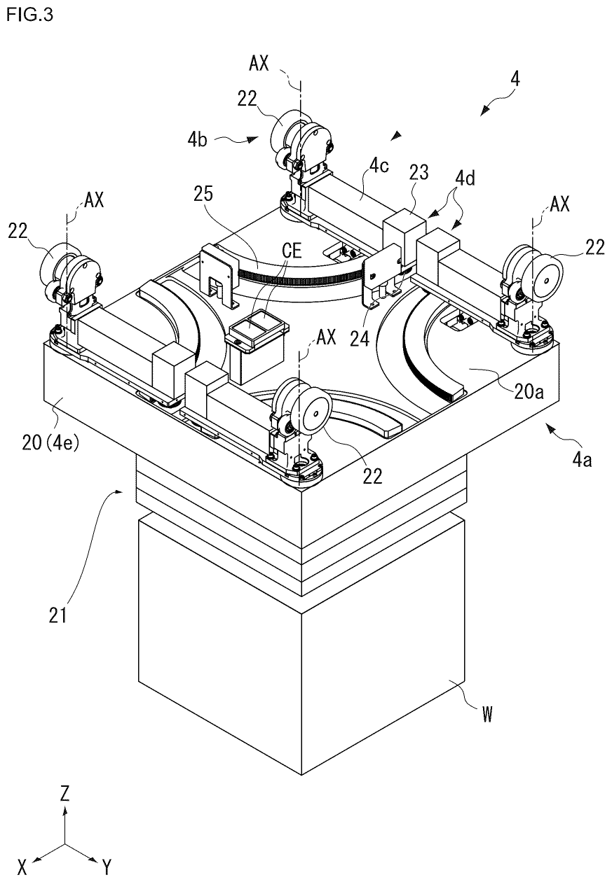

FIG. 3 is a perspective view showing an example of the traveling vehicle. The traveling vehicle 4 includes a main body 4a, travelers 4b, traveling drivers 4c, steerers 4d, and a controller 4e.

The main body 4a is arranged below the tracks 2 (on the −Z side). The main body 4a preferably has, for example, a rectangular or substantially rectangular shape in a plan view. The main body 4a preferably fits in a single grid cell G in the grid-patterned tracks 2 as seen in a plan view. In such a configuration, space is ensured for the traveling vehicle 4 to pass by another traveling vehicle 4 traveling on the adjacent first track R1 or second track R2.

The main body 4a includes an upper unit 20 and a transfer device 21. The upper unit 20 is suspended from the travelers 4b. The upper unit 20 preferably has, for example, a rectangular or substantially rectangular shape as seen in a plan view, and has four corners on the upper surface 20a. The upper unit 20 is provided with a battery BT and charging electrodes CE. For example, the battery BT is provided inside the upper unit 20. The battery BT supplies electric power to each portion of the traveling vehicle 4. The battery BT is, for example, a secondary battery such as a lithium-ion battery. The upper unit 20 is provided with a controller 4e configured or programmed control the traveling of the traveling vehicle itself based on traveling instructions from the controller 5.

The charging electrodes CE are provided on an upper surface 20a of the upper unit 20. In the example shown in FIG. 3, the charging electrodes CE are provided side by side in two locations. Of the two charging electrodes CE, one is electrically connected to the positive terminal of the battery BT. The other charging electrode CE is electrically connected to the negative terminal of the battery BT. The battery BT is supplied with electric power from the charging facility 3 through the charging electrode CE. In other words, when the traveling vehicle 4 reaches the charging location of the charging coupler 10, the charging electrode CE and the charging coupler 10 are electrically connected, and charging of the vehicle's battery BT is initiated.

The transferer 21 is provided below the upper unit 20. The transfer device 21 holds an article W and transfers the article W. For example, the transfer device 21 transfers an article W to or from a storage apparatus or another device. The transfer device 21 can rotate around the rotation axis AX1 along the vertical direction. The transfer device 21 may include, for example, an elevator that raises and lowers the article W, and a lateral extender that moves the article W in a lateral direction (for example, the Y direction).

The traveler 4b includes a traveling wheel 22. The traveling wheel 22 is arranged in each of the four corners on the upper surface 20a of the upper unit 20. Each traveling wheel 22 is driven to rotate by the driving force of the traveling driver 4c. Each traveling wheel 22 rolls on the traveling surfaces of the first track R1, the second track R2, and the partial track R3 of the grid-patterned tracks 2, causing the traveling vehicle 4 to travel along the tracks 2. Each traveling wheel 22 is provided to be capable of pivoting around the pivot axis AX along the Z direction. It should be noted that the configuration is not limited to driving all of the four traveling wheels 22 to rotate by the drive force of the traveling driver 4c, and some of the four traveling wheels 22 may be driven to rotate. The traveling driver 4c is, for example, an electric motor.

The steerer 4d includes a drive source 23, a pinion gear 24, and a rack 25. As the drive source 23, for example, an electric motor is used. The pinion gear 24 is driven to rotate by the driving force generated by the drive source 23. The pinion gear 24 preferably has a circular or substantially circular shape as seen in a plan view and has a plurality of teeth on the outer circumference thereof along the circumferential direction. The rack 25 is fixed to the upper surface 20a of the upper unit 20. The rack 25 has a plurality of teeth which mesh with the teeth of the pinion gear 24, on the outer circumference thereof along the circumferential direction. The pinion gear 24 and the rack 25 are arranged in the state where the teeth of the pinion gear 36 and the teeth of the rack 37 are in mesh with each other. As the pinion gear 24 rotates, the pinion gear 24 moves in the circumferential direction around the pivot axis AX along the outer circumference of the rack 25. This movement of the pinion gear 24 causes the traveling driver 4c and the steerer 4d to pivot together with the pinion gear 24 in the circumferential direction around the pivot axis AX. Through the pivoting of the steerers 4d, the travelers 4b arranged in the four corners of the upper surface 20a each rotate around the pivot axis AX within a 90-degree range.

The controller 4e is configured or programmed to comprehensively control respective portions of the traveling vehicle 4. The controller 4e may be provided in the main body 4a or outside the main body 4a. The controller 4e is configured or programmed to communicate with the controller 5 via a communication network NW. The communication network NW is a transmission line for wireless communication. For example, the communication network NW may be a mobile communication network such as a cellular phone network, a wireless packet communication network, or a short-range wireless communication standard such as ZigBee (registered trademark), Wi-Fi (registered trademark), or BLE.

The controller 4e transmits and receives information to and from the controller 5 via the communication network NW. For example, the controller 4e transmits information indicating the remaining charge of the battery BT (hereinafter, referred to as “battery information”) to the controller 5 via the communication network NW. The battery information is not particularly limited, provided it indicates the remaining battery charge. For example, it may represent the output voltage value or the SOC (State of Charge) of the battery BT. The controller 4e may periodically transmit the battery information to the controller 5 or transmit it at a predetermined timing. The predetermined timing may refer to when the remaining charge of the battery BI falls below a threshold value or when a predetermined time is reached.

The controller 4e periodically transmits the location information of its traveling vehicle to the controller 5. For example, the controller 4e acquires its traveling vehicle's location information using GPS (Global Positioning System), for example. However, the present invention is not limited to this example. The controller 4e may use any commonly known technique to acquire location information, without particular limitations on the acquisition method.

The controller 4e is configured or programmed to cause a traveling vehicle to travel to one of the multiple charging couplers 10 to charge the battery BT when the battery BT requires charging. For example, the controller 4e receives a traveling instruction from the controller 5 via the communication network NW when a vehicle's battery BT requires charging. The traveling instruction includes information on the destination to which the traveling vehicle should proceed in order to charge its battery BT using the charging coupler 10, that is, information on the grid cell G (hereinafter, referred to as “destination information”). Accordingly, the controller 4e causes a vehicle to travel to the destination designated in the traveling instruction. The traveling instruction may also include route information from the current location to the destination, in addition to the destination information.

The controller 5 may be configured or programmed to include a plurality of communicators 30 and a processor 31. The multiple communicators 30 are connected to the processor 31 through either wireless or wired connections. The multiple communicators 30 communicate with the traveling vehicles 4 via the communication network NW. Each of the multiple communicators 30 is assigned a distinct managed range. The managed range is set within the travel range of the traveling vehicle 4.

The communicator 30 communicates with a traveling vehicle 4 located within the managed range assigned to the communicator 30 and receives information from the traveling vehicle 4. The communicator 30 transmits the received information of the traveling vehicle 4 to the processor 31. The communicator 30 transmits information from the processor 31 to the traveling vehicles 4 located within the managed range. In other words, the communicator 30 performs communication between the processor 31 and the traveling vehicle 4 located within the assigned managed range.

The processor 31 transmits and receives information to and from the traveling vehicle 4 via the communicator 30. The processor 31 is connected to multiple charging facilities 3 through wired or wireless connections. The processor 31 communicates with each of the multiple charging facilities 3 to exchange information with each of the multiple charging facilities 3. The processor 31 is configured or programmed to include a storage 40, a charging controller 41, a processor 42, and a traveling controller 43. These configuration components are implemented, for example, by a hardware processor such as a CPU (Central Processor) executing a program (software). Moreover, some or all of these configuration components may be implemented by hardware (including circuitry) such as an LSI (Large Scale Integrated circuit), an ASIC (Application Specific Integrated Circuit), an FPGA (Field-Programmable Gate Array), or a GPU (Graphics Processor), or may be implemented by a combination of software and hardware.

The program is stored in the storage 40, for example. The storage 40 may, for example, include a memory storage (a memory storage including a non-transient storage medium) such as an HDD (Hard Disk Drive) or a flash memory, or may include a removable storage medium (non-transient storage medium) such as a DVD, a CD-ROM, or a USB (Universal Serial Bus). £ The above program may be installed in the storage 40 when a removable storage medium is connected to the controller 5. The storage 40 may include one or more of an HDD, a flash memory, an EEPROM (Electrically Erasable Programmable Read Only Memory), a ROM (Read Only Memory), and a RAM (Random Access Memory).

The charging controller 41 is connected to each of the multiple charging facilities 3. For example, the charging controller 41 can transmit and receive information to and from each charging station 11 of the multiple charging facilities 3 through the communication network NW. The charging controller 41 controls the charging of the traveling vehicle 4 from the charging coupler 10 by controlling the charging station 11 via the communication network NW. The charging controller 41 controls which traveling vehicle 4 is charged by which charging coupler 10 of the charging station 11 while communicating with the charging station 11.

For example, the charging controller 41 transmits a charging instruction to the charging station 11 via the communication network NW. This charging instruction includes, for example, information on the charging coupler 10 that will perform charging. In other words, the charging instruction includes information indicating to which charging coupler 10 electric power is to be supplied (hereinafter, referred to as “supply destination information”). Therefore, as an example, the charging station 11, based on the charging instruction, supplies electric power to the charging coupler 10 indicated by the supply destination information among the multiple charging couplers 10 connected to the charging station 11.

The processor 42 acquires the location information and battery information of each traveling vehicle 4 at regular intervals via the multiple communicators 30. If there is a traveling vehicle 4 that requires charging among the multiple traveling vehicles 4 located on the tracks 2, the processor 42 sets the traveling vehicle 4 as a vehicle for charging. The processor 42 then selects from the multiple charging couplers 10 a charging coupler 10 (hereinafter, referred to as “charging operation target”) to charge the charging target traveling vehicle 4.

For example, the processor 42, when selecting a charging operation target to be connected to and charge the charging target, sets one or more charging couplers 10 located within a predetermined route length from the current location of the charging target traveling vehicle 4 as targets for the selection of the charging operation target (hereinafter, referred to as “selection targets”). The processor 42 then selects one charging coupler 10 from the selection targets as the charging operation target. For example, the processor 42 may select a charging operation target from among the selection targets, based on the current location of the charging target and the charging wait status (charging wait information) of the traveling vehicle 4 for each selection target. The charging wait information may refer to the number of traveling vehicles 4 waiting to be charged at the charging coupler 10 (hereinafter, referred to as “charging-waiting-vehicle count”), or it may refer to the time spent waiting to be charged. The charging-waiting-vehicle count may refer to only the number of traveling vehicles waiting for charging, or it may refer to the total number of traveling vehicles, including those waiting for charging and those currently being charged. For example, the processor 42 may create charging wait information based on the location information of the traveling vehicle 4 and the location information of the charging coupler 10, or it may acquire charging wait information by being input from an external source. Furthermore, the processor 42 may select the charging operation target based on the current location of the charging target, the charging wait information, and the route cost C from the current location of the charging target.

Hereinafter, a non-limiting example of a method for setting the selection target will be described. The processor 42 assumes that all charging couplers 10 within a predetermined route length from the current location of the charging target traveling vehicle 4 are in a state of being in use, and that there is a charging coupler 10 in a state of being available (hereinafter, referred to as “available state”) outside a predetermined range. Here, the state of being in use refers to either a state where the charging coupler 10 is already connected to the traveling vehicle 4 and charging is being performed (hereinafter, referred to as “charging state”), or a state where the charging coupler 10 is not currently connected to the traveling vehicle 4 but is determined to be immediately connected to the traveling vehicle 4. The available state of the charging coupler 10 refers to any state other than being in use, where the traveling vehicle 4 can be charged immediately.

In such a case, even when all charging couplers 10 are in the state of being in use and an charging coupler 10 in the available state exists outside the predetermined range, the processor 42 sets as selection targets the charging couplers 10 located within the predetermined route length from the current location of the charging target.

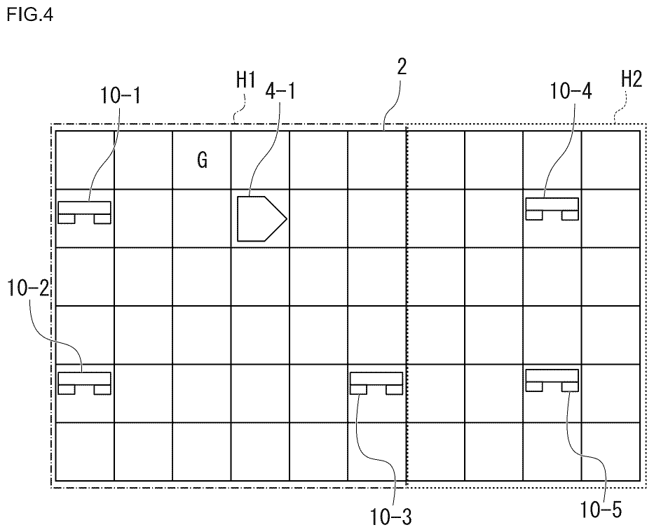

When the processor 42 selects charging couplers 10 within a predetermined range from the charging target as selection targets, it may use the managed range to select charging couplers 10 as the selection targets. The following describes a non-limiting example of a method for setting selection targets using the managed range. FIG. 4 is a diagram for describing the method for setting selection targets using the managed range. In the example shown in FIG. 4, a first managed range H1 of a communicator 30-1 and a second managed range H2 of a communicator 30-2 are assigned within a predetermined range of the tracks 2. Charging couplers 10-1 to 10-3 are installed within the first managed range H1, and charging couplers 10-4 to 10-5 are installed within the second managed range H2.

A traveling vehicle 4-1 (charging target) that requires charging is present in the first managed range H1. The processor 42 receives information of the traveling vehicle 4-1 via the communicator 30-1 and, based on the information of the traveling vehicle 4-1, identifies the traveling vehicle 4-1 as a charging target. If the information of the traveling vehicle 4-1 does not include battery information, the processor 42 may detect that the remaining battery charge of the traveling vehicle 4-1's battery BT has fallen below a threshold value and may thereby identify the traveling vehicle 4-1 as a charging target.

The storage 40 preliminarily stores information of each of the first managed range H1 and the second managed range H2. When the processor 42 identifies the traveling vehicle 4-1 as a charging target, it identifies which managed range the current location of the traveling vehicle 4-1 belongs to, based on the location information thereof. In other words, the processor 42 identifies whether the current location of the traveling vehicle 4-1 belongs to the first managed range H1 or the second managed range H2. In the example shown in FIG. 4, the processor 42 identifies that the current location of the traveling vehicle 4-1 belongs to the first managed range H1. The processor 42 then sets the charging couplers 10-1 to 10-3 existing within the identified first managed range H1 as selection targets.

Here, in selecting a charging operation target, it is conceivable that no upper limit is set on the route length from the current location, and simply, the charging couplers 10 in the available state are treated as selection targets. In such a case, however, it is possible that the charging coupler 10-3 or the charging coupler 10-4, which are far from the current location of the charging target traveling vehicle 4-1, may be set as selection targets, and the charging coupler 10-3 or the charging coupler 10-4 may be selected as the charging operation target. As a result, the charging target traveling vehicle 4-1 must travel a long distance to charge its battery BT, which in some cases could result in depletion of battery charge and halting its operation during the traveling. As a result, the charging of the traveling vehicle 4-1 is delayed significantly, and if the traveling vehicle 4-1 is a transport vehicle, the amount of time available for transport will be reduced.

In a first setting method, when all of the charging couplers 10-1 to 10-3 within the first managed range H1, where the current location of the charging target traveling vehicle 4-1 belongs, are in use, even if there are available charging couplers 10-4 and 10-5 in the second managed range H2, the processor 42 selects the charging couplers 10 in the first managed range Hl as the selection targets. With such a configuration, it is possible to reduce or prevent the charging target traveling vehicle 4-1 from traveling a long distance when charging its battery BT, enabling earlier charging and ensuring sufficient time for transportation use.

When the processor 42 selects charging couplers 10 within a predetermined range from the charging target as selection targets, it may take into account the route cost C. For example, the processor 42 may determine a value by dividing the route length from the current location of the charging target by the route cost C, and select as the selection target the charging coupler 10 where the determined value is within a predetermined range.

Hereinafter, a non-limiting example of a method for selecting a charging operation target from selection targets will be described. For example, the processor 42 selects a charging coupler 10 in the available state as the charging operation target if such a charging coupler 10 exists among the selection targets. Moreover, if there is no available charging coupler 10 among the selection targets, that is, when all the selection targets are in use, the processor 42 selects the selection target with the smallest charging-waiting-vehicle count as the charging operation target. This reduces the imbalance in the charging-waiting-vehicle count for each charging coupler 10, and enables the traveling vehicle system 1 to charge the traveling vehicles as early as possible.

Here, if there is a limit to the number of charging couplers 10 to which the charging station 11 can simultaneously supply electric power, the processor 42 identifies the charging station 11 with the smallest charging-waiting-vehicle count, and selects, as the charging operation target, the charging coupler 10 connected to the identified charging station 11 with the smallest charging-waiting-vehicle count. For example, if any of the charging couplers 10 connected to the identified charging station 11 is in the available state, the processor 42 may select that charging coupler 10 as the charging operation target, and if none of the charging couplers 10 are in the available state, the processor 42 may select the charging coupler 10 with the smallest charging-waiting-vehicle count as the charging operation target.

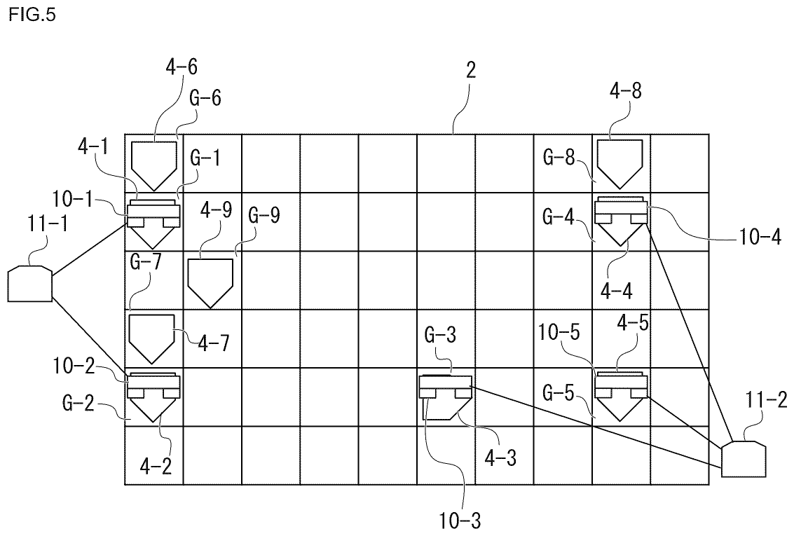

FIG. 5 is a diagram for describing a non-limiting example of a method for selecting a charging operation target. In the example described below, the charging-waiting-vehicle count refers to the number of traveling vehicles waiting for charging, and does not include the number of traveling vehicles currently being charged. In the example shown in FIG. 5, the charging couplers 10-1 to 10-5 are set as selection targets. The charging coupler 10-1 and the charging coupler 10-2 are connected to a charging station 11-1, and the charging couplers 10-3 to 10-5 are connected to a charging station 11-2. Here, the charging coupler 10-1 and the charging coupler 10-2 are in use, with a charging-waiting-vehicle count of 1 for each. In FIG. 5, a traveling vehicle 4-1 is located at a charging location (G-1) of the charging coupler 10-1, and a traveling vehicle 4-6 is waiting at a waiting location (for example, G-6) of the charging coupler 10-1. A traveling vehicle 4-2 is located at a charging location (G-2) of the charging coupler 10-2, and a traveling vehicle 4-7 is waiting at a waiting location (for example, G-7) of the charging coupler 10-2.

The charging coupler 10-4 is in use, with a charging-waiting-vehicle count of 1. Here, the charging coupler 10-3 and the charging coupler 10-5 are in use, but each has a charging-waiting-vehicle count of 0. In FIG. 5, a traveling vehicle 4-3 is located at a charging location (G-3) of the charging coupler 10-3. A traveling vehicle 4-4 is located at a charging location (G-4) of the charging coupler 10-4, and a traveling vehicle 4-8 is waiting at a waiting location (for example, G-8) of the charging coupler 10-4. A traveling vehicle 4-5 is located at a charging location (G-5) of the charging coupler 10-5.

The processor 42 communicates with the charging station 11-1 and the charging station 11-2, and also with the traveling vehicles 4-1 to 4-9, and thereby has information of the charging-waiting-vehicle count for each of the charging stations 11 and the charging couplers 10. In the example shown in FIG. 5, the charging-waiting-vehicle count for the charging station 11-1 is the sum of the charging-waiting-vehicle counts for the charging coupler 10-1 and the charging coupler 10-2, totaling 2. On the other hand, the charging-waiting-vehicle count for the charging station 11-2 is equal to the charging-waiting-vehicle count for the charging coupler 10-4, totaling 1. Therefore, the processor 42 selects one of the charging couplers 10-3 to 10-5, connected to the charging station 11-2, which has the smallest charging-waiting-vehicle counts, as the charging operation target. For example, the processor 42 selects the charging coupler 10 with the smallest charging-waiting-vehicle count from among the charging couplers 10-3 to 10-5.

In the example shown in FIG. 5, the charging coupler 10-3 and the charging coupler 10-5 each have a charging-waiting-vehicle count of 0, making their charging-waiting-vehicle count the smallest. In such a case, the processor 42 may select the charging coupler 10-3, which has the shortest route length from the charging target traveling vehicle 4-9, as the charging operation target, from among the charging coupler 10-3 and the charging coupler 10-5. However, the invention is not limited to this example, and the processor 42 may calculate a parameter for each of charging couplers 10-3 and 10-5, considering both the route length from the charging target traveling vehicle 4-9 and the route cost, and select the charging coupler 10 with the lower parameter as the charging operation target.

The processor 43 can transmit and receive information to and from the traveling vehicle 4 via the communicator 30. The traveling controller 43 controls via the communicator 30 the traveling of the traveling vehicles 4 traveling along the tracks 2. The traveling controller 43 causes the charging target traveling vehicle 4-9 to travel to a charging location where a traveling vehicle 4 can be charged by the charging operation target selected by the processor 42. The traveling controller 43 transmits a traveling instruction to the charging target via the communicator 30 to cause the charging target traveling vehicle 4 to travel to the charging location of the charging operation target selected by the processor 42. If another traveling vehicle 4 is present at the charging location of the charging operation target, the traveling controller 43 causes the charging target traveling vehicle 4-9 to travel to a waiting location different from the charging location.

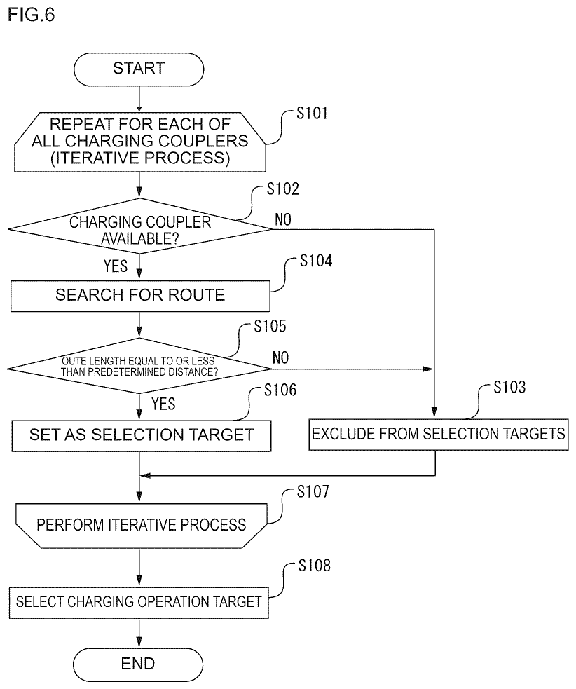

Hereinafter, a first example of a method for selecting a charging operation target according to the present example embodiment will be described, with reference to FIG. 6. FIG. 6 is a flowchart of the first example of the method for selecting a charging operation target according to the present example embodiment. In describing the method for selecting a charging operation target with reference to FIG. 6, it is assumed that the charging target traveling vehicle 4 has already been identified.

When selecting the charging operation target, the processor 42 performs an iterative process for each of all the charging couplers 10 located on the tracks 2, from Step S102 to Step S106, as a first process (Step S101 to Step S107). In other words, the processor 42 sets each of all the charging couplers 10 located on the tracks 2 as a processing target for the first process in order, and sequentially performs the first process on each processing target.

In Step S102, the processor 42 determines whether or not the processing target charging coupler 10 is in the available state. If the processing target is in use, the processor 42 excludes the processing target from the selection targets and ends the first process for the processing target (Step S103). On the other hand, if the processor 42 determines the processing target charging coupler 10 as being in the available state, the processing proceeds to Step S104. In Step S104, the processor 42 searches for a route from the charging target to the processing target charging coupler 10, and calculates the route length and the route cost of the route.

In Step S105, the processor 42 determines whether or not the route length L to the processing target determined in Step S104 is equal to or less than a predetermined distance L1. If the route length L exceeds the predetermined distance L1 in Step S105, the processor 42 excludes the processing target corresponding to the route length L from the selection targets, and ends the first process for that processing target (Step S103). On the other hand, if the route length L is equal to or less than the predetermined distance L1 in Step S105, the processor 42 sets the processing target as a selection target (Step S106), and ends the first process for the processing target (Step S107).

When the iterative process ends, the processor 42 selects, as a charging operation target, the charging coupler 10 with the lowest route cost among the selection targets (Step S108). Once the charging operation target is selected by the processor 42, the traveling controller 43 transmits traveling information to the charging target in order to charge it using the selected charging operation target. The charging target traveling vehicle 4 travels to the grid cell G designated in the traveling information. If the charging operation target is in the available state, the charging target traveling vehicle 4 travels to the charging location of the charging operation target. If the charging operation target is in use, the charging target traveling vehicle 4 travels to the waiting location of the charging operation target.

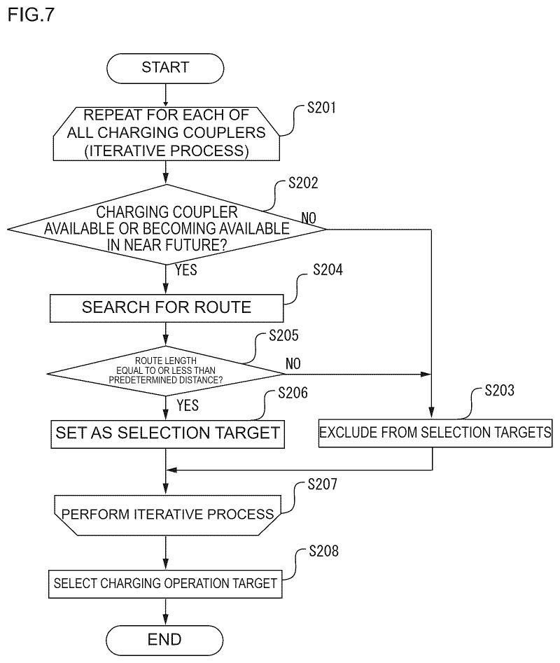

Hereinafter, a second example of the method for selecting a charging operation target according to the present example embodiment will be described, with reference to FIG. 7. FIG. 7 is a flowchart of the second example of the method for selecting a charging operation target according to the present example embodiment. In describing the method for selecting a charging operation target with reference to FIG. 7, it is assumed that the charging target has already been identified.

When selecting the charging operation target, the processor 42 performs an iterative process for each of all the charging couplers 10 located on the tracks 2, from Step S202 to Step S205, as a second process (Step S201 to Step S206). In other words, the processor 42 sets each of all the charging couplers 10 located on the tracks 2 as a processing target for the second process in order, and sequentially performs the second process on each processing target. The processing from Step S203 to Step S207 is the same as that from Step S103 to Step S107, and therefore, the description thereof will be omitted.

In Step S202, the processor 42 determines whether or not the processing target charging coupler 10 is in the available state. If the processor 42 determines that the processing target is not in the available state, that is, it is in use, the processor 42 then determines whether or not the processing target will be released from the in-use state and transition to the available state in the near future. For example, the processor 42 may determine whether or not the processing target will be released from the in-use state and transition to the available state in the near future, based on the remaining battery charge of the traveling vehicle 4 being charged by the processing target and the charging-waiting-vehicle count of the processing target. As an example, the processor 42 may calculate the time until the processing target transitions to the available state (hereinafter, referred to as “release time”), based on the remaining battery charge of the traveling vehicle 4 being charged by the processing target and the charging-waiting-vehicle count of the processing target. If the calculated release time is equal to or less than a predetermined time, the processor 42 may determine that the processing target will be released from the in-use state and transition to the available state in the near future.

If the processor 42 determines that the processing target will not transition to the available state in the near future, it excludes the processing target from the selection targets and ends the first process for the processing target (Step S203). If the processor 42 determines in Step S202 that the processing target charging coupler 10 is not in use, that is, it is in the available state, the processing proceeds to Step S204. As a result, not only the chargers in the available state but also those that will transition to the available state in the near future, become selection targets, broadening the selection options and increasing the likelihood of early charging.

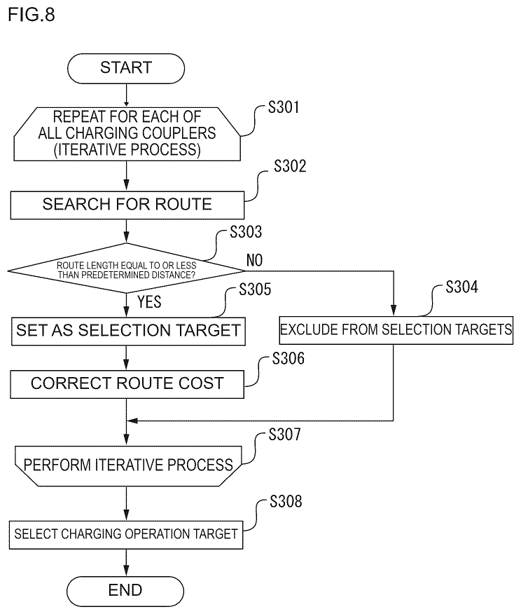

Hereinafter, a third example of the method for selecting a charging operation target according to the present example embodiment will be described, with reference to FIG. 8. FIG. 8 is a diagram for describing the third example of the method for selecting a charging operation target according to the present example embodiment. In describing the method for selecting a charging operation target with reference to FIG. 8, it is assumed that the charging target has already been identified and that all charging couplers 10 are in use.

When selecting the charging operation target, the processor 42 performs an iterative process for each of all the charging couplers 10 located on the tracks 2, from Step S302 to Step S305, as a third process (Step S301 to Step S307). In other words, the processor 42 sets each of all the charging couplers 10 located on the tracks 2 as a processing target for the third process in order, and sequentially performs the third process on each processing target.

In Step S302, the processor 42 uses a commonly known technique to search for a route from the charging target to the processing target charging coupler 10, and calculates the route length L and the route cost C of the route. The route cost C is, for example, a value that fluctuates due to factors such as traffic congestion, and has a link cost. The method for calculating the route cost C is a commonly known technique, and therefore the description thereof will be omitted.

The processor 42 determines whether or not the route length L to the processing target determined in Step S302 is equal to or less than a predetermined distance L1 (Steps S303). If the route length L exceeds the predetermined distance L1 in Step S303, the processor 42 excludes the processing target corresponding to the route length L from the selection targets, and ends the third process for that processing target (Step S304). On the other hand, if the route length L is equal to or less than the predetermined distance L1 in Step S303, the processor 42 sets the processing target as a selection target (Step S305), and corrects the route cost C corresponding to the processing target (Step S306).

For example, in Step S306, the processor 42 corrects the route cost C by multiplying the route cost C obtained in Step S302 by the value of the correction coefficient a raised to the N-th power (α^{N}). The corrected route cost is represented as “route cost C′”. Here, a is a predefined coefficient greater than “1,” and N corresponds to the charging-waiting-vehicle count N at the processing target charging coupler 10. That is to say, in Step S306, the processor 42 calculates the route cost C′ (=C×α^{N}) from the current location of the charging target to the processing target charging coupler 10. In other words, the route cost C′ is a parameter (first parameter) calculated by substituting the route cost C and the charging-waiting-vehicle count N at the processing target charging coupler 10 into a first predetermined function (=C×α^{N}). Once the route cost C′ is calculated, the third process for the processing target ends (Step S307).

When the iterative process ends, the processor 42 selects, as a charging operation target, the charging coupler 10 with the lowest route cost C′ among the selection targets (Step S308). Once the charging operation target is selected by the processor 42, the traveling controller 43 transmits traveling information to the charging target in order to charge it using the selected charging operation target. The charging target traveling vehicle 4 travels to the grid cell G designated in the traveling information. In the example shown in FIG. 5, since all the charging couplers 10 are in use, the charging target traveling vehicle 4 travels to the waiting location of the charging operation target and waits there. Thus, in the selection method of the third example described above, the route cost is corrected based on the charging-waiting-vehicle count N, so that the imbalance in the charging-waiting-vehicle count for each charging coupler 10 is reduced. As a result, charging is initiated early for the charging target, increasing the time available for transport.

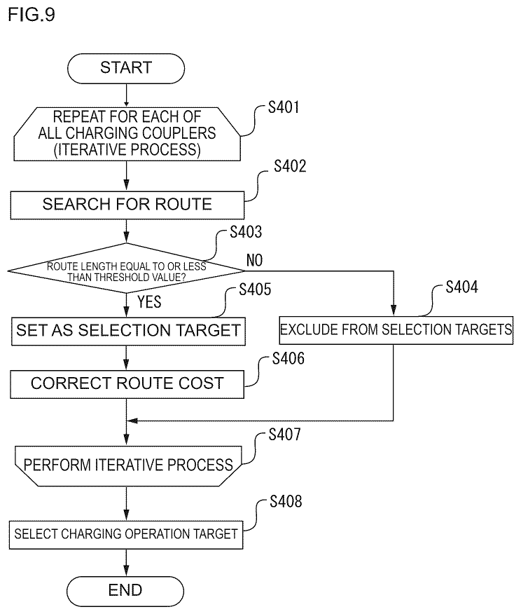

Hereinafter, a fourth example of the method for selecting a charging operation target according to the present example embodiment will be described, with reference to FIG. 9. FIG. 9 is a flowchart of the fourth example of the method for selecting a charging operation target according to the present example embodiment. In describing the method for selecting a charging operation target with reference to FIG. 9, it is assumed that the charging target has already been identified.

When selecting the charging operation target, the processor 42 performs an iterative process for each of all the charging couplers 10 located on the tracks 2, from Step S402 to Step S405, as a fourth process (Step S401 to Step S407). In other words, the processor 42 sets each of all the charging couplers 10 located on the tracks 2 as a processing target for the fourth process in order, and sequentially performs the fourth process on each processing target.

In Step S402, the processor 42 searches for a route from the charging target to the processing target charging coupler 10, and calculates the route length L and the route cost C of the route. The processor 42 divides the route length L to the processing target determined in Step S402 by the route cost to calculate an index d (=L/C). The processor 42 then determines whether or not the index d is equal to or less than a threshold value dth (Step S403). If the index d exceeds the threshold value dth in Step S403, the processor 42 excludes the processing target from the selection targets and ends the fourth process for the processing target (Step S404). On the other hand, if the index d is equal to or less than the predetermined threshold value dth in Step S403, the processor 42 sets the processing target as a selection target (Step S405), and corrects the route cost C corresponding to the processing target (Step S406).

For example, in Step S406, the processor 42 calculates the route cost C* by multiplying the route cost C determined in Step S402 by a function f(Ns, Nc). The variable Ns of the function f is the charging-waiting-vehicle count of the power supplier 12 to which the processing target is connected (second charging-waiting-vehicle count). The variable Ns of the function f is the charging-waiting-vehicle count of the processing target (first charging-waiting-vehicle count). The processor 42 calculates the function f(Ns, Nc) based on the charging wait information, and multiplies the route cost C by the function f(Ns, Nc) to calculate the route cost C*. In other words, the route cost C* is a parameter (second parameter) calculated by substituting the route cost C, the first charge-waiting-vehicle count Nc and the second charging-waiting-vehicle count Ns into a second predetermined function (=C×f(Ns, Nc)). Once the route cost C* is calculated, the processor 42 ends the fourth process for the processing target (Step S407).

When the iterative process ends, the processor 42 selects, as a charging operation target, the charging coupler 10 with the lowest route cost C* among the selection targets (Step S408). Once the charging operation target is selected by the processor 42, the traveling controller 43 transmits traveling information to the charging target in order to charge it using the selected charging operation target. The charging target traveling vehicle 4 travels to the grid cell G designated in the traveling information. If the charging operation target is in the available state, the charging target traveling vehicle 4 travels to the charging location of the charging operation target. If the charging operation target is in use, the charging target traveling vehicle 4 travels to the waiting location of the charging operation target. In the selection method of the fourth example described above, the route cost is corrected according to the second charging-waiting-vehicle count Ns and the first charge-waiting-vehicle count Nc, and therefore, the imbalance in the charging-waiting-vehicle count at each charging station 11 and the imbalance in the charging-waiting-vehicle count at each charging coupler 10 are reduced. As a result, charging is initiated earlier for the charging target, further increasing the time available for transport.

In the above example embodiment, the charging location may be set within a grid cell G (first grid cell) among a plurality of grid cells G defined on the tracks 2, in which the charging coupler 10 can charge the charging target traveling vehicle 4. For example, if another traveling vehicle 4 is present in the first grid cell, the traveling controller 43 may cause the charging target traveling vehicle 4 to travel to a second grid cell, which is different from the first grid cell, as a waiting location. In such a case, the second grid cell may be set at a grid cell G that is within a predetermined range from the first grid cell and through which the traveling vehicle 4 passes least frequently. This configuration reduces or prevents the traveling vehicle 4 waiting to be charged from obstructing the traveling of the traveling vehicle 4 in the transport process.

In a configuration according to an example embodiment of the present invention where a “charger” serves as a charging station 11, the processor 42, for example, selects a charging station 11 from multiple charging stations 11 for charging the charging target traveling vehicle 4, and from the selected charging station 11, selects, for example, a charging coupler 10 with the smallest charging-waiting-vehicle count as the charging coupler to charge the charging target traveling vehicle 4.

The processor 42 may select the charger for which the route length L from the charging target traveling vehicle 4 to the charging location is equal to or less than the predetermined distance L1, or for which the route cost C from the current location of the charging target traveling vehicle 4 to the charging location is equal to or less than a predetermined value. For example, as the processes of Step S105, Step S205, and Step S303, the processor 42 may perform a process of determining whether or not the route cost C from the current position of the charging target traveling vehicle 4 to the current location is equal to or less than a predetermined value.

In the above example embodiment, the controller 5 is a separate device from the traveling vehicle 4, however, the present invention is not limited to this configuration. For example, the controller 5 may be provided within the traveling vehicle 4. In such a case, the communicator 30 of the controller 5 can be omitted.

Example embodiments of the present invention may have at least any of the following configurations.

### Configuration 1

A traveling vehicle system (1) including a plurality of traveling vehicles (4), a plurality of chargers (10 or 11) capable of charging the traveling vehicles (4), and a controller (5) configured or programmed to control traveling of the traveling vehicles (4) and charging of the traveling vehicles (4) by the charger (10 or 11), wherein the controller (5) is configured or programmed to include a processor (42) configured or programmed to select the charger (10) to charge the traveling vehicle (4) to be charged from the plurality of chargers (10 or 11) based on location information of the traveling vehicle (4) to be charged, location information of the charger (10 or 11), and charging wait information that indicates a charging wait status of the traveling vehicle (4) at the charger (10 or 11), if the traveling vehicle (4) requiring charging is present, a traveling controller (43) configured or programmed to cause the traveling vehicle (4) to be charged to travel to a charging location where the traveling vehicle (4) can be charged by the charger (10 or 11) selected by the processor (42), and a charging controller (41) configured or programmed to cause the charger (10 or 11) to charge the traveling vehicle (4) at the charging location.

### Configuration 2

The traveling vehicle system according to configuration 1, wherein the controller (5) is configured or programmed to include a plurality of communicators to communicate with the traveling vehicles (4) located within different managed ranges in a travel range of the traveling vehicles (4), and the processor (42) is configured or programmed to receive information on the traveling vehicle (4) located within each of the managed ranges from the plurality of communicators, and select the charger (10 or 11) within the managed range to which a current location of the traveling vehicle (4) to be charged belongs.

### Configuration 3

The traveling vehicle system according to configuration 1 or 2, wherein the processor (42) is configured or programmed to select the charger (10 or 11) within the managed range to which the current location of the traveling vehicle (4) to be charged belongs, even if all the chargers (10 or 11) in the managed range are in use and the charger (10 or 11) in another managed range is available.

### Configuration 4

The traveling vehicle system according to any one of configurations 1 to 3, wherein the processor (42) is configured or programmed to treat as a selection target the charger (10 or 11) for which a route length (L) from the traveling vehicle (4) to be charged to the charging location is equal to or less than a predetermined distance, or for which a route cost (C) from a current location of the traveling vehicle (4) to be charged to the charging location is equal to or less than a predetermined value.

### Configuration 5

The traveling vehicle system according to any one of configurations 1 to 4, wherein the charging wait status is a number of the traveling vehicles (4) waiting to be charged at the charger (10 or 11).

### Configuration 6

The traveling vehicle system according to any one of configurations 1 to 5, wherein the processor (42) is configured or programmed to select the charger (10 or 11) that charges the traveling vehicle (4) to be charged, based on a first parameter calculated by substituting a route cost (C) from a current location of the traveling vehicle (4) to be charged to the charging location and the charging wait status of the charger (10 or 11) into a first predetermined function.

### Configuration 7

The traveling vehicle system according to any one of configurations 1 to 6, wherein the processor (42) treats as a selection target the charger (10 or 11) for which a value obtained by dividing a route length (L) from a current location of the traveling vehicle (4) to be charged to the charging location by a route cost (C) for the route length (L) is equal to or less than a threshold value.

### Configuration 8

The traveling vehicle system according to configuration 7, further including a power supplier (11) connected to the plurality of chargers (10) to supply electric power to the chargers (10), wherein the power supplier (11) is capable of supplying electric power to only one of the plurality of chargers (10) without simultaneously supplying electric power to the plurality of chargers (10), and the processor (42) is configured or programmed to select the charger (10) that charges the traveling vehicle (4) to be charged, based on a second parameter calculated by substituting the route cost (C), a first charge-waiting-vehicle count (Nc), and a second charging-waiting-vehicle count (Ns) into a second predetermined function, where the first charge-waiting-vehicle count (Nc) is a number of the traveling vehicles (4) waiting to be charged at the charger (10), and the second charging-waiting-vehicle count (Ns) is a number of the traveling vehicles (4) waiting to be charged by the power supplier (11).

### Configuration 9

The traveling vehicle system according to any one of configurations 1 to 8, further including tracks (2) in a grid pattern on which the traveling vehicle (4) travels, wherein the charging location is set within a first grid cell among a plurality of grid cells (G) defined by the tracks (2), in which the charger (10 or 11) can charge the traveling vehicle (4) to be charged.

### Configuration 10

The traveling vehicle system according to configuration 9, wherein if another of the traveling vehicles (4) is present in the first grid cell, the traveling controller (43) is configured or programmed to cause the traveling vehicle (4) to be charged to travel to a second grid cell, which is different from the first grid cell, as a waiting location, and the second grid cell is set at a grid cell (G) that is within a predetermined range from the first grid cell and through which the traveling vehicle (4) passes least frequently.

Example embodiments have been described above. However, the technical scope of the present invention is not limited to the description of the above example embodiments or modifications or combinations thereof. It is apparent to those skilled in the art that various modifications or improvements can be made to the above example embodiments. It is apparent from the scope of claims that the present invention also encompasses one or more of such modifications or improvements. One or more of the elements or features described in the above example embodiment may be omitted in some cases. One or more of the elements or features described in the above example embodiments may be combined where appropriate. The order of executing procedures shown in the example embodiments and modifications or combinations thereof can be implemented in an arbitrary order unless the result of the previous procedure is used in the following procedure. While operations in the above example embodiments have been described with expressions such as “first”, “next”, and “subsequently” for the sake of convenience, the operations need not always be implemented in that order.

The entire contents of Japanese Patent Application No. 2022-152633 and all documents cited herein in the detailed description of example embodiments of the present invention are incorporated herein by reference to the extent permitted by law.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-10. (canceled)

11. A traveling vehicle system comprising:
a plurality of traveling vehicles;
a plurality of chargers capable of charging the traveling vehicles; and
a controller configured or programmed to control traveling of the traveling vehicles and charging of the traveling vehicles by the charger; wherein
the controller is configured or programmed to include:
a processor configured or programmed to select the charger to charge one of the plurality of traveling vehicles to be charged based on location information of the traveling vehicle to be charged, location information of the charger, and charging wait information that indicates a charging wait status of the traveling vehicle at the charger, if the traveling vehicle requiring charging is present;
a traveling controller configured or programmed to cause the traveling vehicle to be charged to travel to a charging location where the traveling vehicle can be charged by the charger selected by the processor; and
a charging controller configured or programmed to cause the charger to charge the traveling vehicle at the charging location.

12. The traveling vehicle system according to claim 11, wherein
the controller is configured or programmed to include a plurality of communicators to communicate with the traveling vehicles located within different managed ranges in a travel range of the traveling vehicles; wherein
the processor is configured or programmed to receive information on the traveling vehicle located within each of the managed ranges from the plurality of communicators, and select the charger within the managed range to which a current location of the traveling vehicle to be charged belongs.

13. The traveling vehicle system according to claim 12, wherein the processor is configured or programmed to select the charger within the managed range to which the current location of the traveling vehicle to be charged belongs, even if all the chargers in the managed range are in use and the charger in another managed range is available.

14. The traveling vehicle system according to claim 11, wherein the processor is configured or programmed to select the charger for which a route length from the traveling vehicle to be charged to the charging location is equal to or less than a predetermined distance, or for which a route cost from a current location of the traveling vehicle to be charged to the charging location is equal to or less than a predetermined value.

15. The traveling vehicle system according to claim 11, wherein the charging wait status is a number of the traveling vehicles waiting to be charged at the charger.

16. The traveling vehicle system according to claim 15, wherein the processor is configured or programmed to select the charger that charges the traveling vehicle to be charged, based on a first parameter calculated by substituting a route cost from a current location of the traveling vehicle to be charged to the charging location and a value indicating the charging wait status of the charger into a first predetermined function.

17. The traveling vehicle system according to claim 11, wherein the processor is configured or programmed to select the charger for which a value obtained by dividing a route length from a current location of the traveling vehicle to be charged to the charging location by a route cost for the route length is equal to or less than a threshold value.

18. The traveling vehicle system according to claim 17, further comprising:
a power supplier connected to the plurality of chargers to supply electric power to the chargers; wherein
the power supplier is capable of supplying electric power to only one of the plurality of chargers, rather than simultaneously supplying electric power to the plurality of chargers; and
the processor is configured or programmed to select the charger that charges the traveling vehicle to be charged, based on a second parameter calculated by substituting the route cost, a first charge-waiting-vehicle count, and a second charging-waiting-vehicle count into a second predetermined function, where the first charge-waiting-vehicle count is a number of the traveling vehicles waiting to be charged at the charger, and the second charging-waiting-vehicle count is a number of the traveling vehicles waiting to be charged by the power supplier.

19. The traveling vehicle system according to claim 11, further comprising:
tracks in a grid pattern on which the traveling vehicle travels; wherein
the charging location is within a first grid cell among a plurality of grid cells defined by the tracks, in which the charger can charge the traveling vehicle to be charged.

20. The traveling vehicle system according to claim 19, wherein
if another of the traveling vehicles is present in the first grid cell, the traveling controller is configured or programmed to cause the traveling vehicle to be charged to travel to a second grid cell, which is different from the first grid cell, as a waiting location; and
the second grid cell is located at a grid cell within a predetermined range from the first grid cell and through which the traveling vehicle passes least frequently.
